(19) United States
(12) Patent Application Publication
(10) Pub. No.: US 2012/0124484 A1
(43) Pub. Date: May 17, 2012

(54) SYSTEM AND METHOD FOR COLLABORATION IN PROJECT DEVELOPMENT

(75) Inventors: Phillip James Robinson, Histon (GB); Simon Matthew Tutin, Ely (GB)

(73) Assignee: GENERAL ELECTRIC COMPANY, Schenectady, NY (US)

(21) Appl. No.: 12/945,241

(22) Filed: Nov. 12, 2010

(51) Int. Cl. G06F 3/00; G06F 3/033

(52) U.S. Cl. 715/753

(57) ABSTRACT

A system for collaboration in project development includes a central server including a collaboration controller configured to support a virtual whiteboard and two or more remote servers located in different locations and coupled to the central server. The two or more remote servers are configured to receive user information from one or more input devices during an information gathering session, to provide the user information to the central server, to receive information from the central server and to provide the information received from the central server to the one or more input devices. The central server is further configured to prevent the virtual whiteboard from being displayed on the one or more input devices during the information gathering session.

### BACKGROUND OF THE INVENTION

The subject matter disclosed herein relates to development projects and, in particular, to collaboration in project development.

Many projects require multiple working groups working in multiple stages to achieve a desired result. Typically, at least some planning is performed before the project is begun to define and coordinate the different stages and assign responsibility for them to certain individuals.

One paradigm for project development is the so-called “waterfall model.” The waterfall model is a rigidly structured, sequential project development process that flows from one phase to another. In the waterfall process, the project does not move from a current phase to the next phase until the current phase is completed. In this manner, progress is seen as flowing steadily downwards (like a waterfall) through the phases of the development. The waterfall model was originally used for manufacturing projects and was an early model used in the development of software where it experienced varying degrees of success.

Another development process that may be employed in project development is the “agile” development model. In the case of a software project, such a model is commonly referred to as “agile software development.” Agile software development may generally be defined as including iterative and incremental software development stages, where the requirements and solutions for each stage evolve through collaboration between self-organizing, cross-functional teams.

Agile methods emphasize face-to-face communication over written documents when the team is all in the same location. When a team works in different locations, they maintain contact (typically daily) through videoconferencing, voice, e-mail, etc.

Most agile teams work in a single open office called a bullpen in order to facilitate communication. Team size is typically small (5-9 people) to help make team communication and team collaboration easier. Larger development efforts typically include multiple teams working toward a common goal or different parts of an effort. This may also require a coordination of priorities across teams.

Agile software development typically includes one or more “sprints” were the actual software code is developed. To guide the sprint, members of a team work together to define the problems the code is to solve in a sprint planning session. During the sprint planning session the team devises the plan for the sprint to deliver the selected deliverables for the sprint. The team meets again to perform a retrospective after each sprint to evaluate the positives and negatives of the sprint.

A technique for facilitating ideas in both exercises (sprint planning and retrospective) is to have individual team members write their ideas onto sticky notes and affix them on a white board for further discussion. However, when a team is not co-located then this is logistically difficult. One way of solving this is to use collaboration tools like electronic whiteboards, where all the remote team members (or even different teams) can see the same “whiteboard.” However, it is difficult for multiple members to use the whiteboard at the same time and so, normally, the members are forced to take turns using the whiteboard. While polite, taking turns creates a problem because one member's ideas may be seen by the others and end up consciously or unconsciously influencing the other's input. This is detrimental to the goal of forming as many original and new ideas up on the board as possible.

### BRIEF DESCRIPTION OF THE INVENTION

According to one aspect of the invention, a system for collaboration in project development is disclosed. The system of this aspect includes a central server including a collaboration controller configured to support a virtual whiteboard and two or more remote servers located in different locations and coupled to the central server. The two or more remote servers of this aspect are configured to receive user information from one or more input devices during an information gathering session, to provide the information to the central server, to receive information from the central server and to provide the information received from the central server to the one or more input devices. In this aspect, the central server is further configured to prevent the virtual whiteboard from being displayed on the one or more input devices during the information gathering session.

According to another aspect of the invention a computer implemented method for collaboration in project development is disclosed. The method of this aspect includes receiving an indication that an information receiving session has been declared; receiving user information at user input devices; posting the user information to one of a plurality of remote servers upon receipt of a post indication from a user; placing the user information on a virtual white board supported by a central server in communication with the plurality of remote servers; and disallowing display of the virtual whiteboard on the user input devices until the information receiving session is completed.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a system for collaboration in agile project development according to one embodiment of the present invention; and

FIG. 2 is flow diagram of a method according to one embodiment.

The detailed description explains embodiments of the invention, together with advantages and features, by way of example with reference to the drawings.

### DETAILED DESCRIPTION OF THE INVENTION

According to one embodiment, participants in sprint planning or sprint retrospectives use mobile devices that act as virtual note taking devices. These participants are remotely located so that physically interacting with one collaboration device is impossible. The notes the participants create on their mobile device can be electronically “thrown” onto an electronic collaboration screen where they may then be rearranged in priority order, sorted, discarded and the like. In one embodiment, participants are not allowed to see the notes of others until an idea/information receiving period is completed.

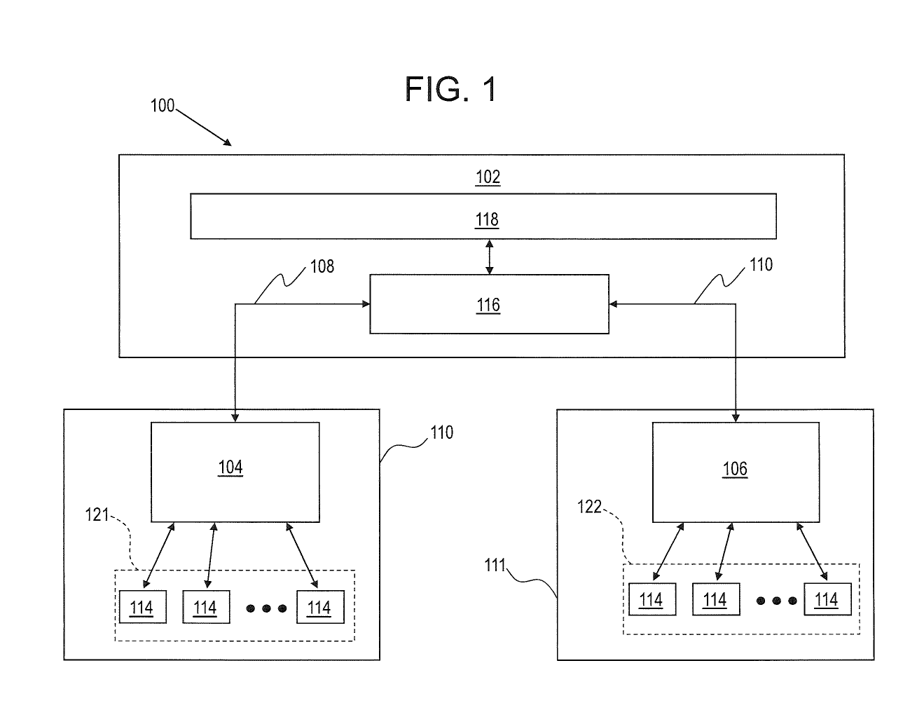

FIG. 1 shows an example of a collaboration system 100 according to one embodiment of the present invention. It shall be understood that the system 100 includes multiple elements. Of course, systems according to embodiments of the present invention may require only some of the elements shown in FIG. 1. That is, not every element shown in the system 100 is required in each embodiment of the present invention.

The system 100 includes at least one central server 102 and one or more remote site servers 104, 106. In FIG. 1 only a first remote site server 104 and a second remote site server 106 are illustrated. Of course, the system 100 can include additional remote site servers in one embodiment. In addition, the system 100 can include additional central servers 102. In one embodiment, the remote servers 104, 106 are located in different locations.

The central server 102 is shown coupled to the remote site servers 104, 106 by communication links 108, 110, respectively. It shall be understood that the communication links 108 and 110 can be unidirectional or bidirectional and can be hardwired, wireless, or a combination of both.

The remote site servers 104, 106 include programming or logic that allows it to receive information from one or more input devices 114. That is, the remote site servers 104 and 106 are configured to accept information from the input devices 114. The input devices 114 can be physically or wirelessly coupled to the remote site servers 104, 106. The input devices 114 are hand-held mobile devices in one embodiment. The remote site servers 104, 106 provide the information received from the input devices 114 to the central server 102.

In one embodiment, a first group 121 of input devices 114 is communicatively coupled to the first remote server 104 at a first location 110 and a second group 122 of input devices 114 is communicatively coupled to the second remote server 106 at a second location 111. In one embodiment, the second location 111 is geographically separated from the first location 110. For example, a wall or other divider may exist between the first location 110 and the second location 111 or the first location 110 may be one or more miles from the second location 111. In one embodiment, all of the input devices 114 in the first group 121 are in the same room as each other and all of the input devices 114 in the second group 122 are in the same room as each other.

In one embodiment, the central server 102 includes a collaboration controller 116. The collaboration controller 116 supports and controls access to a virtual white board 118. In such an embodiment, the collaboration controller 116 is coupled to the remote site servers 104, 106 by communication links 108, 110, respectively.

In general, the virtual white board 118 can receive information from the input devices 114 (via communication controller 116) and display the information for all of the users of the input devices 114 to view. In one embodiment, the information is displayed to appear as sticky notes on a white board. In one embodiment, the information provided by others is not provided to a particular user until after a predetermined time period is tolled or a particular information gathering session is completed. In one embodiment, each user can see the ideas the user posted even though the user cannot see the ideas posted by other users. In one embodiment, the collaboration controller 116 does not provide information from one user to another user until certain conditions are met.

As discussed above, in the typical case, a sprint planning or retrospective occurs in a room with all participants present. However, as working groups are becoming more dispersed, having all participants in the same room has become increasingly difficult. As such, the system 100 shown in FIG. 1 can be utilized to provide collaborative development where one or more groups are team members are dispersed in different locations. In particular, the system 100 can be utilized in agile software development. For example, the system 100 may be utilized for sprint planning or sprint retrospective sessions associated with agile software development.

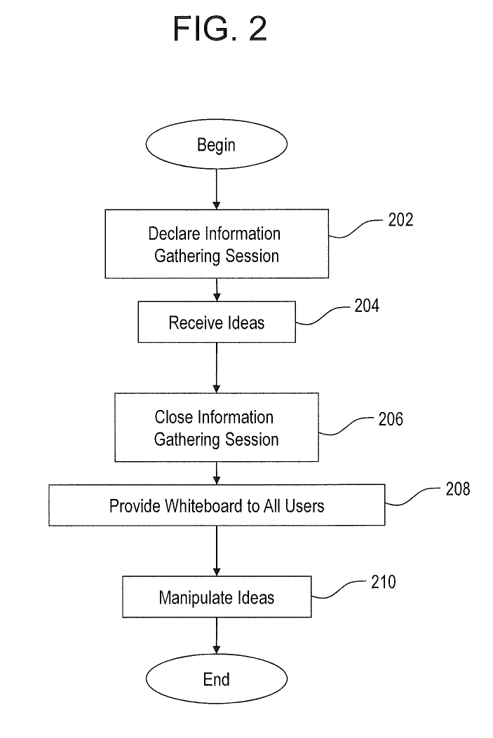

FIG. 2 is a block diagram of a method of operating the system 100 shown in FIG. 1 according to one embodiment. The description of this method will also include further description of elements shown in FIG. 1.

Processing begins at block 202 where an information gathering (e.g., brainstorming) session is declared. In one embodiment, one user is a “leader” and has control over the collaboration controller 116. This control may be provided by, for example, through one of the input devices 114. One of ordinary skill will readily realize that designation of leader or other designations are easily implemented.

After the information gathering session is declared, at block 204 ideas are received. Receiving the ideas includes several steps in one embodiment. For example, the ideas may first be provided to one of the input devices 114. Once provided to the input device 114, the user can then determine when and if to post the idea to the virtual white board 118. Posting can include either pressing a “post” button or other indication on the input device 114. In one embodiment, user gestures may be utilized to post an idea. For example, the input device 114 may be configured to receive user-interface gestures (i.e. touch-screen based movements of fingers) or actions involving movement of the input device 114 (e.g. a swing of the arm in a throwing motion while holding the input device 114). Regardless of how posted, the posted information is received by the remote sever near the input device 114 and provided to the collaboration controller 116 for addition to the virtual whiteboard 118. The input devices 114 may be any type of hand-held device such as, for example, a hand-held computer, cellular phone, or other computing device capable of providing information to the remote servers 104, 106.

At block 206 the information gathering session is closed. The information gathering session may be closed based on expiration of a predetermined time period or when the leader decides to close the session. Of course, the information gathering session could be closed in other manners. For example, if the rate at which new ideas are received falls below a predetermined level, the session may be closed.

At block 208, a representation of the virtual whiteboard 118 is provided to the team members via input devices 114. In one embodiment, the display includes some or all of the received ideas displayed as sticky notes on a board. The notes can then rearranged, deleted, expanded or otherwise manipulated at block 210.

One technical effect of the system and method provided above relates to overcoming the problem of working collaboratively between remote teams.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for collaboration in agile project development, the system comprising:
a central server including a collaboration controller configured to support a virtual whiteboard; and
two or more remote servers located in different locations and coupled to the central server, the two or more remote servers configured to receive user information from one or more input devices during an information gathering session, to provide the user information to the central server, to receive information from the central server and to provide the information received from the central server to the one or more input devices;
wherein the central server is further configured to prevent the virtual whiteboard from being displayed on the one or more input devices during the information gathering session.

2. The system of claim 1, further comprising:
the one or more input devices.

3. The system of claim 2, wherein the one or more input devices are configured to accept the user information and to provide it to one of the two or more remote servers.

4. The system of claim 3, wherein the input devices provide the user information after a user interface gesture is received.

5. The system of claim 4, wherein the user interface gesture is a throwing motion of the input device or a finger gesture received by a touch screen of the user interface device.

6. The system of claim 1, wherein the central server is further configured to allow the virtual whiteboard to be displayed on the one or more input devices after the brainstorming session is completed.

7. The system of claim 6, wherein the virtual white board includes representations of the user information as sticky tabs.

8. The system of claim 1, wherein the project is a software project.

9. A computer implemented method for collaboration in project development, the method comprising:
receiving an indication that an information receiving session has been declared;
receiving user information at user input devices;
posting the user information to one of a plurality of remote servers upon receipt of a post indication from a user;
placing the user information on a virtual white board supported by a central server in communication with the plurality of remote servers; and
disallowing display of the virtual whiteboard on the user input devices until the information receiving session is completed.

10. The method of claim 9, further comprising:
indicating that the information receiving session is completed; and
allowing display of the virtual whiteboard on the user input devices after the information receiving session is completed.

11. The method of claim 9, wherein the post indication is a throwing motion of the input device or a finger gesture received by a touch screen of the user interface device.

12. The method of claim 9, wherein at least two of the plurality of remote servers are located in different locations.

13. The method of claim 9, further comprising:
designating a leader; and
wherein the leader causes the information receiving session to be declared.

14. The method of claim 9, wherein at least one of the user input devices is a cellular phone or a hand held computer.
